(19) United States
(12) Patent Application Publication
(10) Pub. No.: US 2011/0153929 A1
(43) Pub. Date: Jun. 23, 2011

(54) DISK MEMORY UTILIZATION MANAGEMENT USING AVAILABLE SLOT CLUSTERS

(75) Inventor: Ravi Nallappan, Sungai Buloh (MY)

(73) Assignee: INTERNATIONAL BUSINESS MACHINES CORPORATION, Armonk, NY (US)

(21) Appl. No.: 12/644,091

(22) Filed: Dec. 22, 2009

(51) Int. Cl. G06F 12/00

(52) U.S. Cl. 711/112; 711/159; 711/E12.001; 707/822

(57) ABSTRACT

Efficient reclamation of available memory slots in a computer memory storage unit is achieved by identifying clusters of available memory spaces resulting from the deletion of a record from the storage unit. A cluster may include one or more contiguous available memory slots. An active cluster is elected by selecting the larger of two clusters, the first being the largest cluster resulting solely from processing of the current record delete request and the second being an active cluster identified in a prior record delete operation. Other clusters are defined as passive clusters. When a record is to be written into the disk memory, available memory slots in the active cluster are first used, following by unused memory slots and then by available memory slots in passive clusters.

### BACKGROUND

The present invention relates generally to computer storage management and more particularly to management of the utilization of computer memory storage devices, such as disk memories, using chains of clustered available memory slots.

Computer systems commonly include a high speed input/output cache memory in the data path between the computer processor subsystem and a higher capacity but lower speed computer memory storage unit, such as a magnetic disk drive. The cache memory can reduce the number of accesses that must be made to the disk drive to read, write or update records stored on the disk drive. Well known read-ahead and write-behind techniques improve cache memory utilization and thus input/output bandwidth.

When a data record is to be written into a computer memory storage unit, the data record is typically broken up into data blocks that are written into memory. The term memory slot should be taken to mean the smallest unit of memory addressable by the system that controls storage of the record. Conventionally, an attempt is first made to utilize available memory slots for a record to be written; that is, slots which were previously allocated to an older record and subsequently made available for re-use upon deletion of the older record.

Ideally, the free memory slots allocated to a data record to be written are contiguous, which speeds up the write and any later read operations. That ideal is rarely realized. Over time, as records of different sizes are written into or deleted from the memory storage unit, the available memory slots tend to become separated from another, a condition commonly referred to as data fragmentation.

Data fragmentation can be a serious issue in data management systems, particularly where using sequential access memory storage units such as magnetic disk drives. It takes time to move a disk drive read/write head into the right position relative to particular memory slot on a moving disk surface in order to be able to write a record block into or delete or retrieve it from the particular memory slot. If the blocks for a particular record are stored in physically separated memory slots, the time required to complete any memory operation involving the record may be greatly increased because of the time required to reposition the read/write head between successive slot access operations. Data fragmentation clearly adversely affects disk drive access time requirements and can cause overall system performance degradation.

There is a need for a storage management innovation that can be implemented in various embodiments that address the data fragmentation problem without unduly burdening the processing resources of the computing environment in which the embodiment is employed.

### SUMMARY

The invention may be embodied as a method for managing a computer memory storage unit having a plurality of contiguous memory slots for storing data records. When a request is received for deletion of a data record stored in the computer memory storage unit, each memory slot occupied by the data record in the computer memory storage unit is identified as available. One or more clusters is identified with each cluster including one or more contiguous available memory slots. A linked list of the identified clusters is generated.

The invention may also be embodied as a computer program product including a computer-usable media having computer-usable program instructions stored therein. The instructions, when loaded into and executed by a computer, cause the computer to perform a method for managing a computer memory storage unit having a plurality of contiguous memory slots for storing data records. The method includes receiving a request for deletion of the data record stored in a computer memory storage unit, identifying each memory slot in the computer memory storage unit occupied by the data record as being available, identifying one or more clusters where each cluster includes one or more contiguous available memory slots, and generating a linked list of the identified clusters.

Finally, the invention may be embodied as a computer system that includes a computer memory storage unit having a plurality of contiguous memory slots for storing data records and a memory management module for managing the computer memory storage unit. The memory management module includes in an erase module for receiving a request for deletion of a record stored in the computer memory storage unit and for identifying each memory slot occupied by the record as an available memory slot. The memory management module further includes cluster identifying logic for identifying one or more clusters of memory slots to each cluster includes one or more contiguous available memory slots. Finally, the memory management module includes a list generator module for generating a linked list of the identified clusters.

### BRIEF DESCRIPTION OF THE SEVERAL VIEWS OF THE DRAWINGS

FIG. 1 is a high-level block diagram of the major components of a system in which the invention may be implemented.

FIG. 2 is a graphical representation of the organization of memory space in a computer memory storage unit, such as a disk memory.

FIG. 3 is a high-level flowchart of the major memory management operations performed in accordance with the invention.

FIG. 4 is a more detailed flowchart of operations performed in the course of deleting a record previously stored in a computer memory storage unit.

FIG. 5, consisting of FIGS. 5A and 5B taken together, is a more detailed flowchart of operations performed in identifying clusters of available memory slots.

FIG. 6 is an illustration of the fields in one embodiment of a cluster record.

FIG. 7 is a high-level flow chart of operations performed in writing a record into a computer memory storage unit managed in accordance with the present invention.

FIG. 8 is a more detailed flow chart of operations performed in writing a record into a computer memory storage unit managed in accordance with the present invention.

FIG. 9 illustrates graphic or representations for different memory slot states, including a slot in use, an unused slot, an active roster slot, a passive cluster slot and an unprocessed free slut.

FIG. 10, consisting of FIGS. 10A and 10B taken together, illustrates the states of memory slots in a memory in the course of a series of a record adds and deletes.

FIG. 11 in a high-level block diagram of the functional infrastructure of a computer system that may be used to implement an embodiment of the invention.

### DETAILED DESCRIPTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium having computer-usable program code stored in the medium.

Any combination of one or more computer usable or computer readable storage medium(s) may be utilized. The computer usable or computer readable storage medium may be, for example but not limited to, an electronic, magnetic, optical, electromagnetic, infrared, or semiconductor system, apparatus, or device. More specific examples (a non-exhaustive list) of computer usable mediums would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, or a magnetic storage device. Note that the computer usable storage medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer usable medium may be any medium that can contain or store the program for use by or in connection with the instruction execution system, apparatus, or device.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The computer program code may execute entirely on a user's computer as a stand-alone software package or as an integrated component of a larger software package, partly on the user's computer and partly on a remote computer or entirely on remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The following description will indicate where specific program code is or can be executed in a network of computer devices.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operations to be performed on the computer or other programmable apparatus to produce a computer implemented process such that the instructions which execute on the computer or other programmable apparatus provide processes for implementing the functions/acts specified in the flowchart and/or block diagram block or blocks.

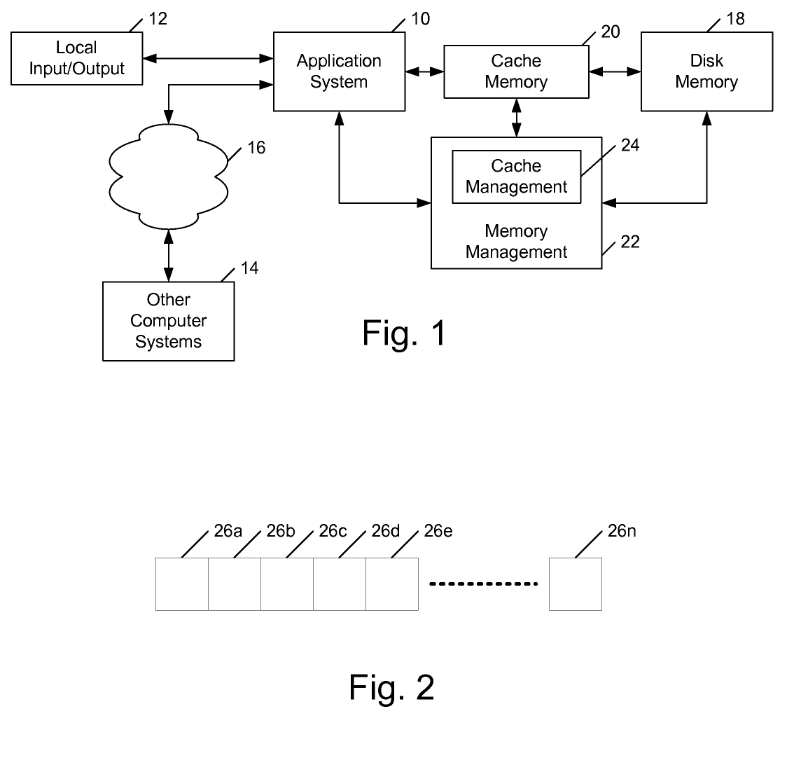

FIG. 1 is a high-level functional block diagram of a computer system in which the invention may be implemented. The computer system includes an application system 10 that, under the control of an operating system, runs one or more computer applications. The applications system 10 communicates with local users through local input/output devices 12 that conventionally include devices like keyboards, pointing devices, and display monitors, printers, etc. The application system 10 may communicate with other remote computer systems 14 through networks 16.

To support applications being executed in the application system 10, the system may use one or more computer memory storage units, such as disk memory 18. Disk memory 18 can be used to store the code for applications to be executed in the application system 10 as well as data required for or resulting from the execution of an application. As already noted, performing disk access operations for disc memory devices takes time and potentially can, potentially, slow down the execution of applications in the application system 10.

To reduce the impact of disc access operations, it is well known to employ a small, faster cache memory 20 in the data path between the application system 10 and the disk memory 18. Application data to be written into disk memory 18 is first written into cache memory 20 and later transferred into disk memory 18 under the control of a cache management subsystem 24, part of a larger memory management subsystem 22 and the computer system. Data required by executing application is transferred from the disk memory 18 into cache memory 20 at least temporarily. Data stored in cache memory 20 can be retrieved by cache management subsystem 24 for use by applications running in application system 10.

While the inclusion of a cache memory generally improves the performance of the system, some of the benefits of having a cache memory are lost when the disk memory becomes fragmented; that is, when record blocks are stored in discontiguous memory slots rather than contiguous memory slots in the disk memory.

Referring to FIG. 2, a computer memory, such as a disk memory, can be considered as having a number addressable data storage locations or slots 26a through 26n. Where a record to be stored in the disk memory 18 is larger than the size of a memory slot, the record is broken up into blocks which are stored in several slots in the memory. Generally, a memory can be categorized as including used memory space (memory slots into which at least one record block has previously been written) and unused memory space (memory slots into which no record blocks have yet been written). A memory slot into which a record was written is considered to be part of the used memory space even if that record is no longer needed and has been processed as being deleted from the memory. A memory slot previously occupied by now-deleted record block can be characterized as an available memory slot.

The conventional data storage approach is to reuse available slots in used memory space to the extent possible before making use of slots in the current unused memory space. The invention provides an effective way to reuse available memory slots.

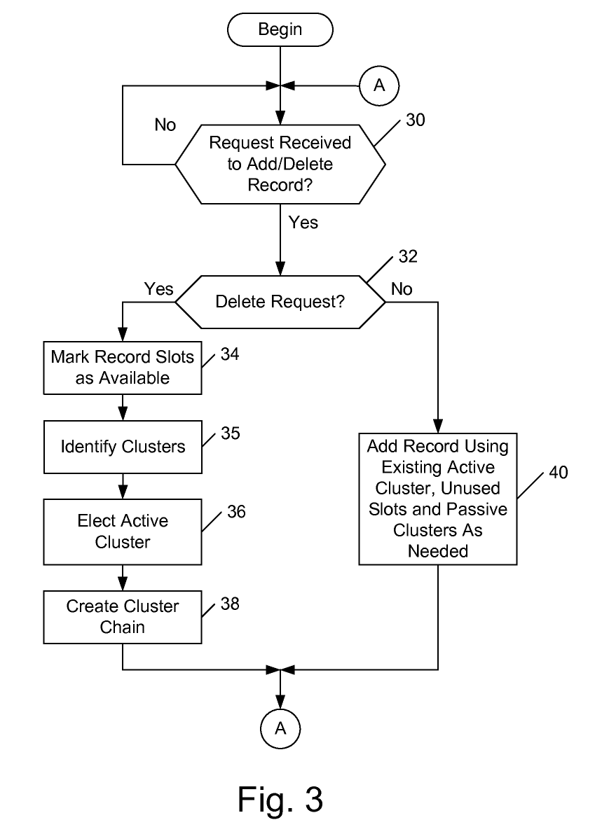

In accordance with the invention, slots in the used memory space that are available for reuse are grouped into clusters where each cluster consists of one or more contiguous available memory slots. FIG. 3 is a high-level flow chart of basic operations performed in reusing available memory slots in a computer memory storage unit in accordance with the invention. The process begins when a request is received in an operation 32 to either add or delete a record from a memory storage unit. A determination 32 is made whether the received request is a request to delete a previously stored record from the memory. If the received request is a delete request, the memory slots occupied by the record are identified as available in an operation 34. Clusters of available memory slots are identified in operation 35 with each cluster having one or more contiguous available memory slots. An active cluster is elected in operation 36. All clusters other than the elected active cluster will be treated as passive clusters. Active and passive clusters are treated differently when available memory slots are subsequently reclaimed by writing a new record into the memory. Details of the election process and of the differences in roles played by the active cluster and passive clusters are provided below. A linked list or chain of the identified clusters is created in an operation 38 with each cluster containing a pointer to the next cluster and, in some embodiments, to the previous cluster as well. More information relating to the linked list and the manner in which it is used during memory reclamation is provided below. Creation of the cluster chain ends delete request processing and the system returns to waiting for another record delete or add request.

Returning to operation 32, if the determination had been that the received request was not a delete request, then the received request is processed as a request to add a record to the memory. The operations 40 performed in adding a record to the memory make use of available memory slots in the existing active cluster, then unused memory slots and finally available memory slots in passive clusters in writing record blocks to the memory. A record may be too large for the number of unused and available memory slots in the memory. If that happens, an error message is generated or thrown to indicate to the memory management subsystem that the add operation has failed. Once the add-record processing is complete, the system returns to waiting for another record add or delete request.

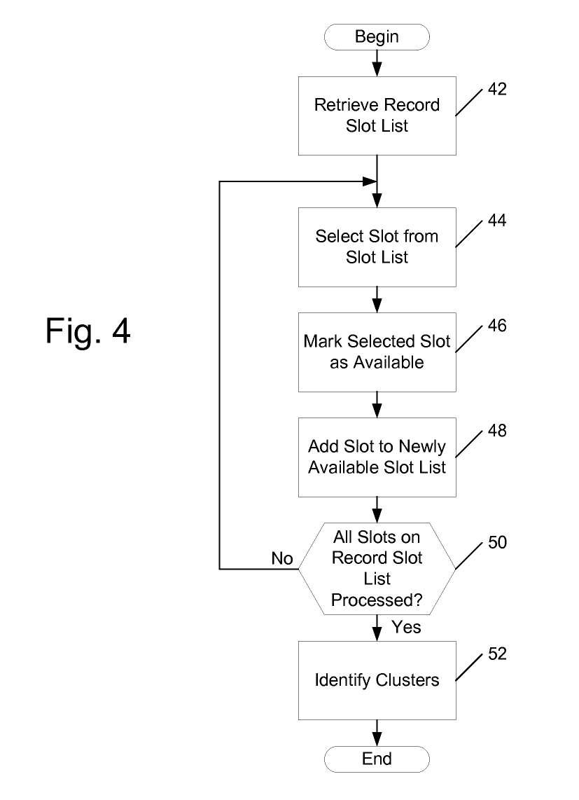

FIG. 4 is a more detailed flowchart of some of the steps performed in processing a record delete request. When the record is stored at the request of an application running in application system 10, a record of the slots in which the record is stored is created and maintained by the application as metadata. The previously created list is retrieved in an operation 42 and a slot in that list is selected in an operation 44. The selected slot can be marked as being available in an operation 46, normally by flipping an in use/available flag recorded in a special field in the slot. Typically, the contents of the slot are not actually erased when the slot is identified as available on the assumption the contents will be overwritten when a new record block is later written into the slot. The newly available slot is added, in an operation 48, to a newly available slot list that identifies all of the slots that have become available as a result of processing the current record delete request. A check is then made (operation 50) as to whether all slots in the retrieved record slot list have been processed. If operation 50 shows that at least one additional record slot has not yet been processed, the process loops back to operation 44 and the next unprocessed slot is selected and processed using the steps described above. Once all of the slots in the retrieved record spotless have been processed, an operation 52 is performed to identify clusters.

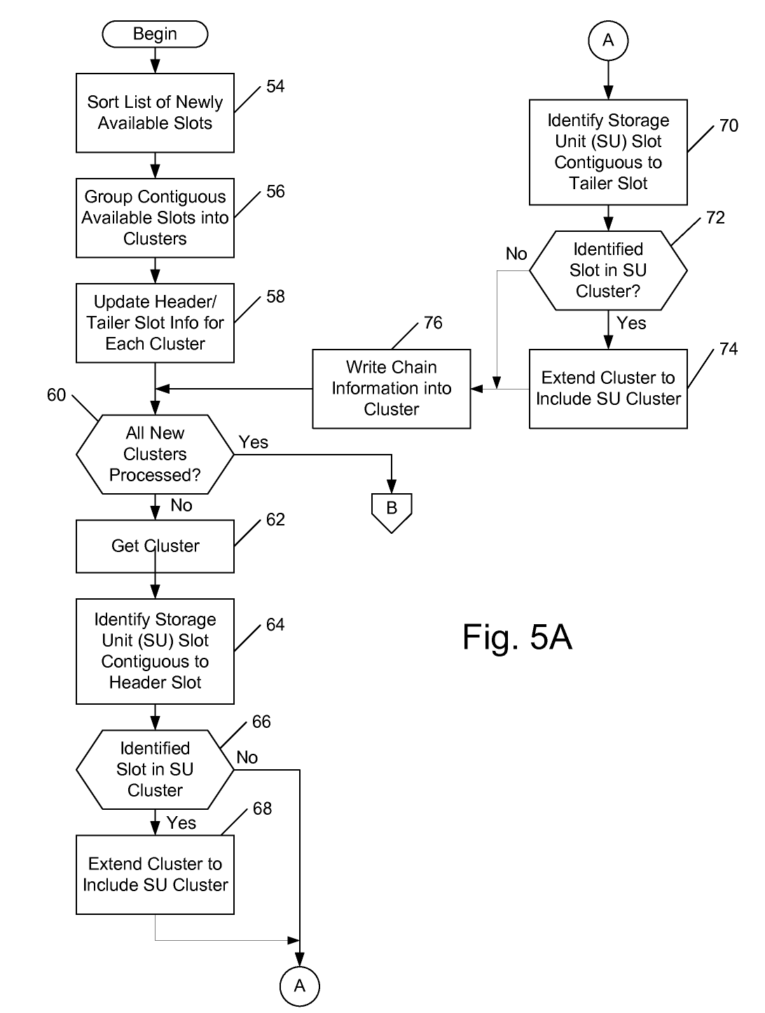

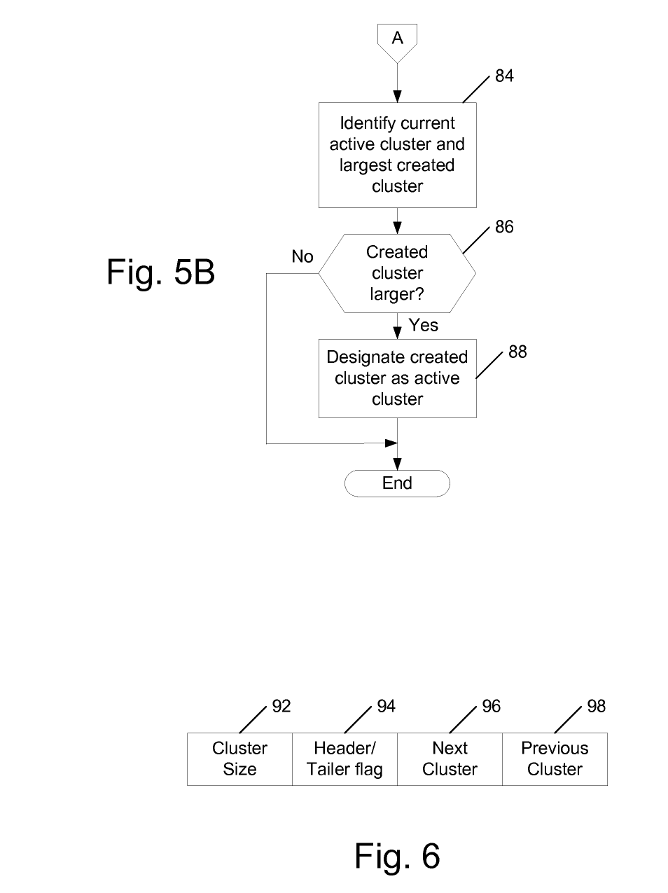

FIG. 5, consisting of FIGS. 5A and 5B taken together, is a more detailed flowchart of steps performed in identifying clusters of available memory slots and designating one of those clusters as the active cluster. As noted earlier, a list of memory slots that have become newly available as a result of processing the current delete-record request is created. That list is sorted in an operation 54 using slot offset numbers. The sorting operation is necessary because the record slot list itself may be an unsorted list of the memory slots in which blocks of the deleted record were stored. For example, a record slot list show that a particular record was previously stored in blocks 14, 3, 1, 15, 4 and 2 in a memory. The sorting operation shows that the stored record actually occupied two different sets of contiguous memory slots, set one being slots 1-4 and set two being slots 14 and 15. Contiguous available slots are grouped into clusters in an operation 56. By definition, a cluster includes one or more available memory slots. The first slot in the cluster is identified as the header slot for the cluster while the last slot in the cluster is identified as the tailer slot. Cluster data, such as cluster size, header/tailer flags, etc. is generated for each cluster in an operation 58.

The clusters that are identified up to this point in the process are limited to clusters formed as a result of processing the most recent delete-record request. Newly formed clusters provide an incomplete picture of available memory space in the memory since it is possible that other memory slots are currently available as a result of the processing of prior record delete requests. A series of operations must be performed to merge any newly formed clusters with previously existing available memory slots. The merge operations effectively allow newly formed clusters to grow in size by adding available memory slots that already exist in the computer memory storage unit.

An initial step in the process is a determination 60 whether all newly formed clusters have been processed. Obviously, at the beginning of the merge operations, not all of the newly formed clusters will have been processed. The first newly formed cluster is selected in an operation 62 and a check 64 is made as to the status of the storage unit slot that is contiguous to the header slot of the cluster just selected in operation 62. If the contiguous storage unit slot is found (in operation 66) to be part of a cluster already available in the storage unit, the newly formed cluster is extended (operation 68) to include the available memory slots in the already available storage unit cluster.

Upon completion of the steps described above, the program proceeds to operation 70, which identifies the storage unit slot contiguous to the tailer slot of the newly formed cluster. A determination 72 is made whether the identified storage unit slot is part of an existing cluster in the storage unit. If it is, the newly formed cluster is extended in an operation 74 to include the slots in the existing cluster. Chaining information is written (operation 76) into the newly formed cluster, which may or may not have been extended to include contiguous clusters already existing in the storage unit.

The writing of the chaining information completes the processing for the newly formed (and possibly extended) cluster and the program returns to the input of operation 60 to select the next newly formed cluster to be processed. Each newly formed cluster is processed in turn in accordance with the steps described above.

Once all of the clusters resulting from the delete-record operations have been processed, the current largest cluster must be identified and designated as the active cluster. The current active cluster is a cluster that had been designated as the active cluster as a result of an earlier iteration of the process being described. The sizes of the previously designated active cluster and the largest cluster resulting from processing of the delete operation are compared in an operation 86. If the largest newly created cluster is larger than the previously designated active cluster, the largest newly created cluster is designated as the new active cluster in an operation 88. If the largest newly created cluster is the same size or smaller than the currently designated active cluster, the currently designated active cluster retains that designation. Once the active cluster is elected, all other clusters take on the role of being passive clusters, which alters how they are used in memory reclamation operations to be described below.

Several references have been made to information maintained for header and tailer slots in formed clusters. FIG. 6 represents information that could be included in the cluster header or tailer slot in at least one embodiment of the invention. The slot information could include a field 92 specifying the size of the cluster, a flag 94 identifying the slot as a header slot or a tailer slot or both (for a single slot cluster), a field 96 specifying the address of the next cluster, and a field 98 specifying the address of the previous cluster in the chain of clusters.

The formation of clusters as the result of a record delete operation, the selection of the largest cluster as the designated active cluster, and the designation of other clusters as passive clusters has been described. The use of those clusters and of previously unused memory space when a record is being added to the memory will be described below.

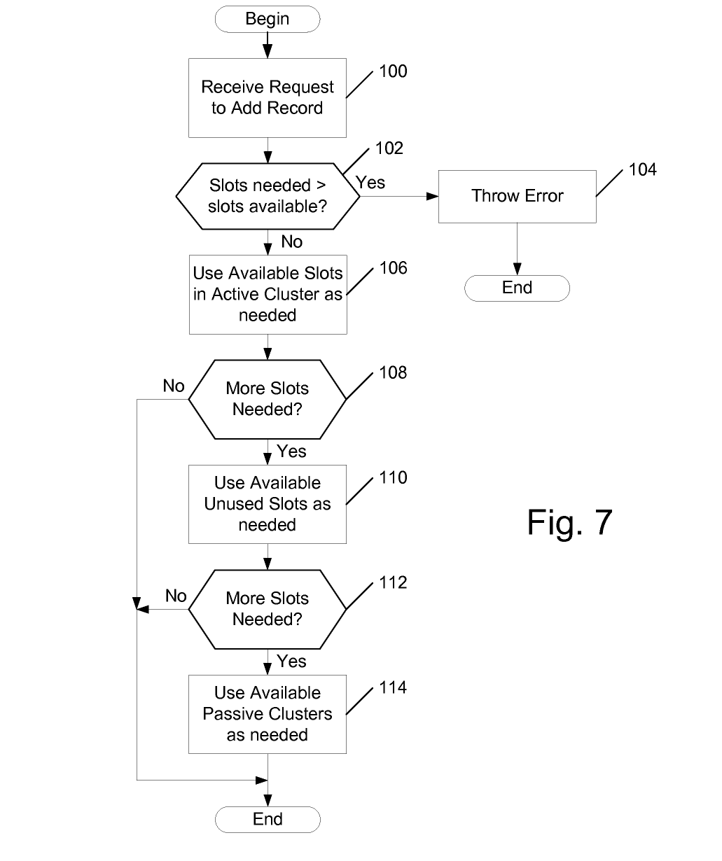

FIG. 7 is a high level flow chart of operations performed when adding a record to a disk memory for which an active cluster and one or more passive clusters have been designated. A request to add a record to the disk memory is received in an operation 100. The number of slots required by the record is compared to the total number of available slots in memory in an operation 102. If total number of slots available is less than the number needed, an error 106 is thrown and the add-record processing ends.

If operation 102 shows the number of memory slots available is equal to or greater than the number of record blocks to be written, the system first uses available memory slots contained in the designated active cluster (operation 106). If the number of available slots in the active cluster is great enough to accommodate the record being added, the add-record processing ends. The active cluster will, of course, shrink by the number of slots used in satisfying the add record request.

If it is determined (operation 108) that the number of slots required to add the record is greater than the number of slots available in the designated active cluster, then available unused slots in the memory are used (operation 110) to provide additional slots. If the record can be added using only available slots in the active cluster and unused slots in the memory, the add record processing ends. Since all of the available slots in the active cluster will have been used, there will be no longer be a cluster identified as the active cluster.

If it is determined (operation 112) that the add-record request cannot be completed using only the active cluster slots and previously unused slots, then available slots in passive clusters are utilized (operation 114) to complete the add-record processing.

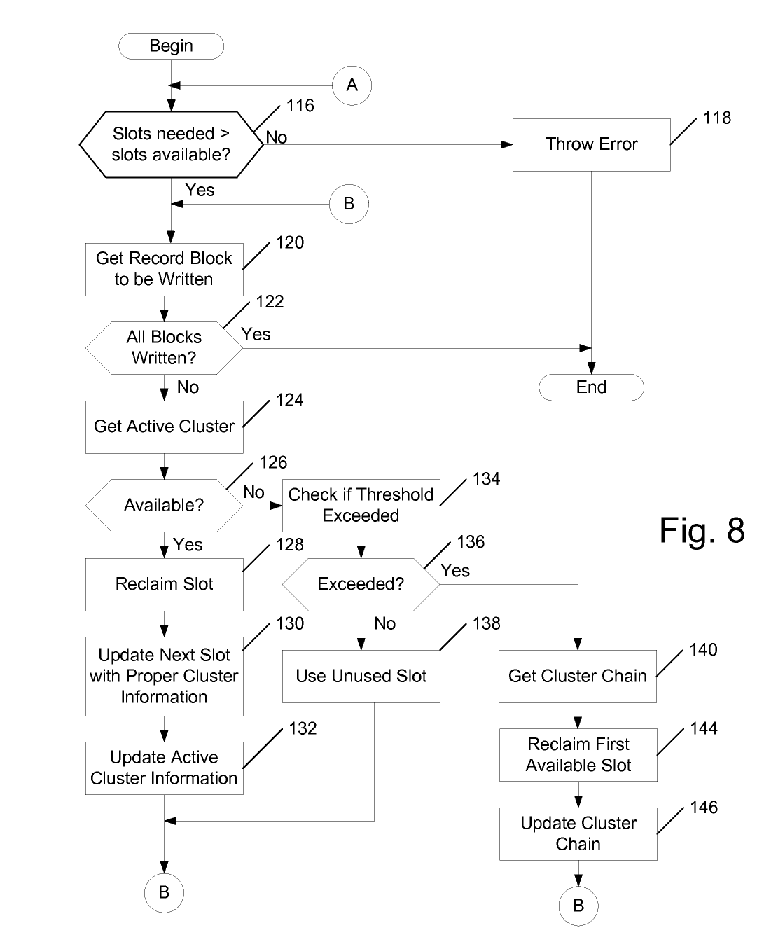

In one embodiment of the invention, the steps generally described with reference to FIG. 7 are actually carried out on a block-by-block basis. FIG. 8 is a more detailed flowchart of the steps performed. As previous noted, an initial operation 116 is performed to determine whether the number of slots required for the record to be written is greater than the number of available slots in the memory into which record is intended to be written. If an insufficient number of memory slots is available, an error is thrown (operation 118) and the add-record processing ends. However, if a sufficient number of memory slots is available, a record block to be written is requested in an operation 120. If the response 122 to that request is there are no record blocks to be written (meaning that one or more record blocks has already been written in prior iterations of the process), the process is ended. If operation 122 indicates there is a record block to be written, a request 124 is made for the active cluster or, more specifically, for the address of the header slot in the active cluster. As noted earlier, an active cluster identified as a result of earlier processing of a delete record request can shrink and even disappear as a result of subsequent processing of add record requests.

If it is determined in an operation 126 that there is still a designated active cluster including one or more available memory slots, the active cluster header slot is reclaimed by writing a record block into that slot in an operation 128. If the active cluster includes at least one additional available memory slot, that slot is designated as the new header slot for the active cluster in an operation 130. Active cluster information retained in the system is updated in an operation 132 before the program loops back to the input of operation 120 to begin processing of any additional record blocks that may exist.

If it is determined by operation 126 that an active cluster no longer exists, a check 134 is made as to whether the memory threshold has already been exceeded; that is, whether the memory still contains any unused memory slots. If Operation 136 shows that the threshold has not been exceeded (that is, the memory still contains at least one unused memory slot), the record block is written into the lowest numbered unused memory slot and the state of that slot is changed from unused to used. A last-used slot metadata value is also updated to reflect the changes. Once those steps are taken, the program control returns to requesting the next record block (if any) remaining to be written.

If the check 136 were to show that the memory threshold has been exceeded (meaning there are no remaining unused memory slots), cluster chaining information about any passive clusters is requested in an operation 140. If a passive cluster is found to be available in an operation 142, the first available slot in that passive cluster is reclaimed by writing the record memory block into it in an operation 144. Information about the cluster changes are updated in an operation 146 before the program loops back to the input 120 to determine whether there are additional record blocks to be written.

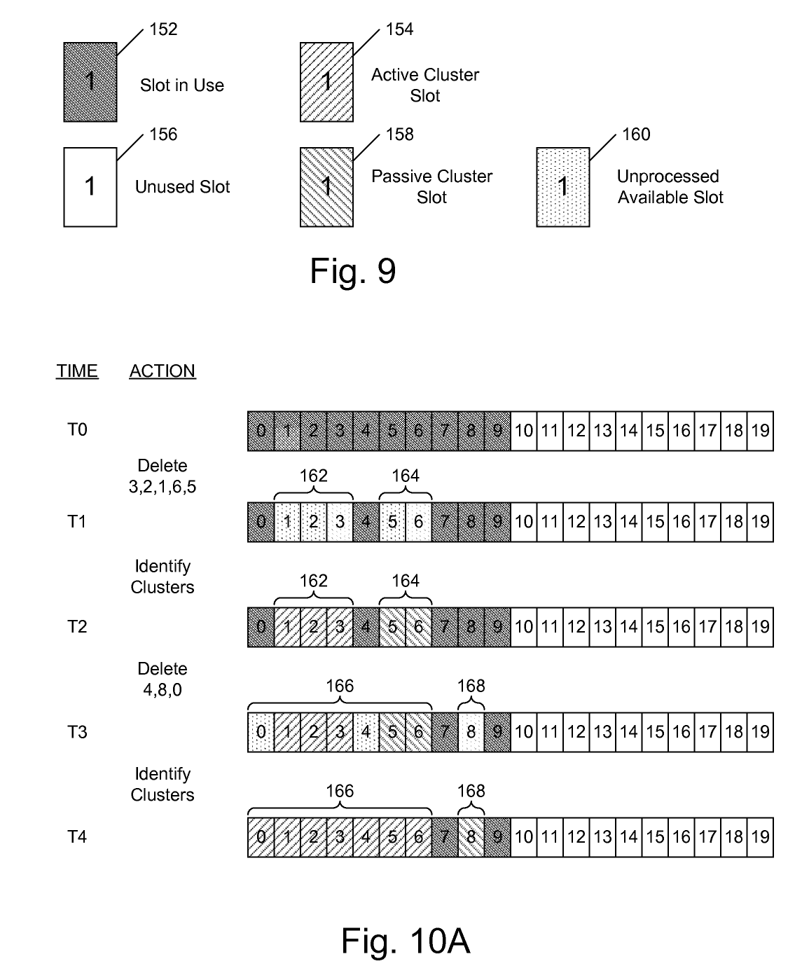

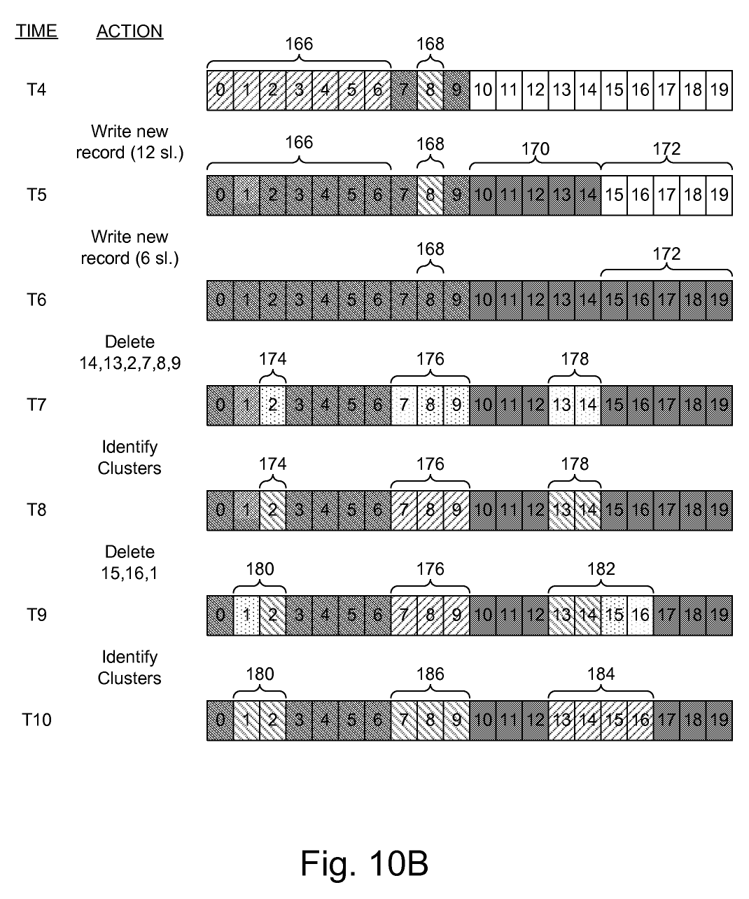

The results of operation as described above are illustrated in FIG. 9 and FIG. 10, which consists of FIGS. 10A and 10B, taken together, the hypothetical add-record and delete-record operations. FIG. 9 includes a set of memory slots, each of which has a current state identified by the type of graphic fill. A memory slot 152 currently occupied by a record block is indicated by a relatively dark solid fill. An available memory slot 154 in the current active cluster is designated by parallel forward-slanted lines. An unused slot 156 is represented by having no fill. An available slot 158 in a passive cluster is represented by parallel backward-slanted lines while a slot 160 that has become newly available but not yet assigned to either an active or passive cluster is designated by relatively light solid fill.

FIG. 10 depicts the states of memory slots 0-19 in a disk memory at different times T0, T1, T2, etc. either before or after records are deleted from or add to the memory. The actual number of slots in memory would, of course, be much greater than the twenty slots shown. The graphic representation is limited to twenty slots to simplify the illustration.

At time T0, it is shown that memory slots 0-9 are occupied by record blocks while memory slots 10-19 have yet to be used. Assume a request is received to delete a record defined in a record slot list as occupying memory slots 3, 2, 1, 6 and 5. At time T1, each of those slots will be identified as available for reuse. When the slots are sorted, it can be seen that two clusters 162 and 164 of memory slots have become available. At time T2, cluster 162 is identified as the current active cluster as it is larger than cluster 164. Cluster 164 is left as a passive cluster.

It is assumed that a second delete record operation is initiated between times T2 and T3, resulting in memory slots 0, 4 and 8 being identified as newly available. The newly available memory slots 0 and 4 extend the previously designated clusters 162 and 164 to form a longer cluster 166 of available memory spaces, as shown at time T3. The now available memory slot 168 forms a new “cluster” that consists solely of slot 168. At time T4, the cluster 166 is designated as the new active cluster while slot 168 becomes a single slot passive cluster.

It is assumed that a request to write a new record is received at between time T4 and time T5 and that the record requires the use of 12 available memory slots. In accordance with the invention, the first seven record blocks are written into the memory slots 0-6, defined as being part of active cluster 166, while the next five record blocks are written into previously unused memory slots 10-15, shown as a set 170 of memory slots at time T5.

Assume another add-record request to add a six block record is received between time T5 and time T6. When this record request is processed, the first five record blocks will be written into the set 172 of previously unused memory slots 15-19 while the sixth record block will be written into the single block passive cluster 168. When these actions are completed at time T6, it can be seen at every memory slot in the storage unit is now occupied by a record block.

Assume a request is received between times T6 and T7 to delete a record occupying memory slots 14, 13, 2, 7, 8 and 9. When the delete-record processing is completed at time T7, three sets of memory slots 174, 176, and 178, each including at least one newly available memory slot, are identified. At time T8, set 176 (being the largest of the three sets) is designated as the active cluster while sets 174 and 178 assume the roles of passive clusters.

Assume another record delete request is received between times T8 and T9 calling for deletion of a record occupying memory slots 15, 16 and 1 in the disk memory. When the record delete operations are completed at time T9, it can be seen that what had been a single slot passive cluster 174 will grow to a two slot cluster 180 while the previously identified two slot passive cluster 178 will have grown to a four slot cluster 182. As part of the delete-record processing the size of the largest cluster (cluster 182) resulting from the current delete-record processing is compared to the largest previously designated active cluster (cluster 176). When it is determined that the largest cluster resulting from the current delete record processing is the larger of the compared values, it is designated as the new active cluster, shown as cluster 184 at time T10. The previously designated active cluster 176, now having lost its designation as the active cluster, automatically takes on the role of a passive cluster 186 shown at time T10.

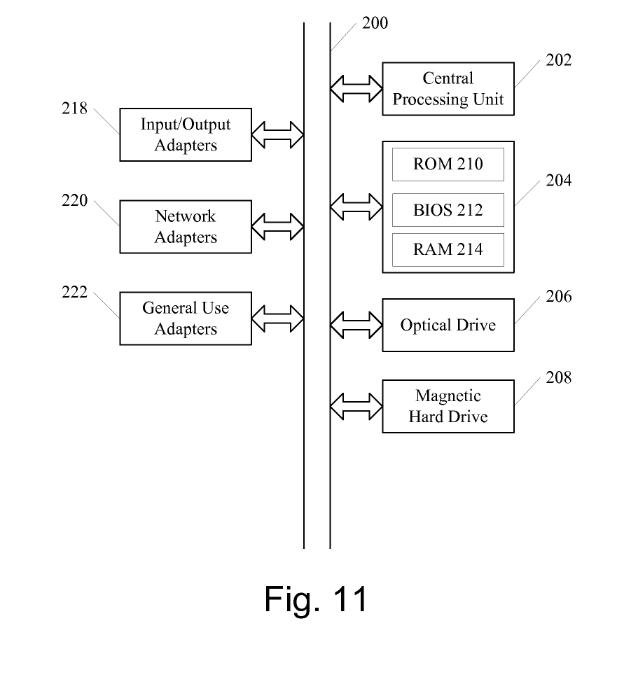

The functions performed by the memory management subsystem can be implemented by programming a general purpose programmable computer having the functional infrastructure illustrated in FIG. 11. The computer system includes an internal system bus 200, a system processor 202, internal memory components 204 and one or more “external” memory components, such as magnetic hard drive 208. If sized properly, the magnetic hard drive 208 could be used as the required disk memory in implementing the invention. Alternatively, an external drive (not shown) might be used to provide the required disk memory. The internal memory 204 includes specific types of memory such as read only memory (ROM) 210, basic input/out system (BIOS) memory 212 and random access memory (RAM) 214. The BIOS 212 stores configuration information for the computer system and basic routines used to control the transfer of information among the components of the computer system. Drives, such as optical drive 206 and hard drive 208, provide non-volatile storage for applications and processes that execute in the computer system and for data used in and/or generated by those applications and processes.

The computer system also includes a significant number of input/output (I/O) adapters 218 that provide interfaces between a variety of input/output devices and the remainder of the computer system. Common examples of input/output devices include keyboards, pointing devices, monitors and printers. The computer system can be connected to other systems through network adapters 220, which may support wired or wireless network connections. Finally, the computer system may include what are characterized as general use adapters 222 that can be used for a number of different purposes. For example, USB (Universal Serial Bus) adapters can be used to connect typical input/output devices (such as keyboards, monitors, etc.), auxiliary memory devices, such as flash memory cards, portable hard drives and even high capacity magnetic hard drives, wireless network transceivers and many other kinds of devices to the computer system.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for managing a computer memory storage unit having a plurality of contiguous memory slots for storing data records, said method comprising:
receiving a request for deletion of a data record stored in said computer memory storage unit;
identifying each memory slot occupied in said computer memory storage unit by said data record as an available memory slot;
identifying one or more clusters, each cluster comprising one or more contiguous available memory slots; and
generating a linked list including said identified clusters.

2. A method according to claim 1 wherein identifying one or more clusters further comprises identifying the largest of the clusters as an active cluster

3. A method according to claim 2 wherein identifying one or more clusters further comprises:
identifying each cluster comprising one or more contiguous memory slots made available as a result of processing said received request for deletion of said data record;
identifying any clusters existing in said computer memory storage unit at the time said request for deletion of a data record was received; and
combining any cluster comprising one or more contiguous memory slots made available as a result of processing said received request for deletion of said data record with any cluster existing in said computer memory storage unit at the time said request for deletion of a data record was received to form a single larger cluster.

4. A method according to claim 3 wherein identifying the largest of the clusters as an active cluster further comprises:
comparing the largest cluster resulting from combining any cluster comprising one or more contiguous memory slots made available as a result of processing said received request for deletion of said data record with any cluster existing in said computer memory storage unit at the time said request for deletion of a data record was received with the active cluster existing in said computer memory storage unit at the time said request for deletion of a data record was received; and
designating the larger of the compared clusters as the active cluster.

5. A method according to claim 4 further comprising:
receiving a request to add a data record to said computer memory storage unit; and
writing at least part of the data record into the designated active cluster.

6. A computer program product comprising a computer-usable medium having computer-usable program instructions stored therein, said computer-usable program instructions, when loaded into and executed by a computer, causing the computer to perform a method for managing a computer memory storage unit having a plurality of contiguous memory slots for storing data records, said method comprising:
receiving a request for deletion of a data record stored in said computer memory storage unit;
identifying each memory slot occupied in said computer memory storage unit by said data record as an available memory slot;
identifying one or more clusters, each cluster comprising one or more contiguous available memory slots; and
generating a linked list including said identified clusters.

7. A computer program product according to claim 6 wherein identifying one or more clusters further comprises identifying the largest of the clusters as an active cluster.

8. A computer program product according to claim 7 wherein identifying one or more clusters further comprises:
identifying each cluster comprising one or more contiguous memory slots made available as a result of processing said received request for deletion of said data record;
identifying any clusters existing in said computer memory storage unit at the time said request for deletion of a data record was received; and
combining any cluster comprising one or more contiguous memory slots made available as a result of processing said received request for deletion of said data record with any cluster existing in said computer memory storage unit at the time said request for deletion of a data record was received to form a single larger cluster.

9. A computer program product according to claim 8 wherein identifying a new active cluster further comprises:
comparing the largest cluster resulting from combining any cluster comprising one or more contiguous memory slots made available as a result of processing said received request for deletion of said data record with any cluster existing in said computer memory storage unit at the time said request for deletion of a data record was received with the active cluster existing in said computer memory storage unit at the time said request for deletion of a data record was received; and
designating the larger of the compared clusters as the active cluster.

10. A computer program product according to claim 9 wherein the method further comprises:
receiving a request to add a data record into said computer memory storage unit;
beginning to add the data record by writing at least part of the data record into the designated active cluster.

11. A computer system comprising;
a computer memory storage unit having a plurality of contiguous memory slots for storing data records;
a file system management module for managing said computer memory storage unit, said file system management module comprising
an erase module for receiving a request for deletion of a data record stored in said computer memory storage unit and for identifying each memory slot occupied by the data record in said computer memory storage unit as an available memory slot,
cluster identifying logic for identifying one or more clusters of memory slots, each cluster comprising one or more contiguous available memory slots, and
a list generator module for generating a linked list including said identified clusters.

12. A computer system according to claim 11 wherein said cluster identifying logic further comprises logic for identifying the largest of the clusters as an active cluster and all other clusters as passive clusters.

13. A computer system according to claim 12 wherein said cluster identifying logic further comprises:
new cluster identifying logic for identifying each cluster comprising one or more contiguous memory slots made available as a result of processing said received request for deletion of said data record;
existing cluster logic for identifying any clusters existing in said computer memory storage unit at the time said request for deletion of a data record was received; and
cluster combination logic for combining any cluster comprising one or more contiguous memory slots made available as a result of processing said received request for deletion of said data record with any cluster existing in said computer memory storage unit at the time said request for deletion of a data record was received to form a single larger cluster.

14. A computer system according to claim 13 wherein the logic for identifying the largest of the clusters as an active cluster further comprises:
logic for comparing the largest cluster resulting from combining any cluster comprising one or more contiguous memory slots made available as a result of processing said received request for deletion of said data record with any cluster existing in said computer memory storage unit at the time said request for deletion of a data record was received with the active cluster existing in said computer memory storage unit at the time said request for deletion of a data record was received; and
logic for designating the larger of the compared clusters as the active cluster.
